(19) United States
(12) Patent Application Publication
(10) Pub. No.: US 2007/0091894 A1
(43) Pub. Date: Apr. 26, 2007

(54) Method and terminal and system for improving transmission rate by using ACK piggybacking of TCP in asynchronous wireless network environment

(75) Inventors: Chin-Kyu Kang, Suwon-shi (KR); Byeong-Woo Kim, Suwon-shi (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/496,124

(22) Filed: Jul. 31, 2006

(30) Foreign Application Priority Data
Oct. 7, 2005 (KR) 2005-94610

(51) Int. Cl. H04L 12/56

(52) U.S. Cl. 370/394; 370/349

(57) ABSTRACT

Disclosed is a system, apparatus and method for improving a transmission rate by using an ACK piggybacking of a TCP in an asynchronous network environment. When an ACK packet for confirming reception of TCP data downloaded from a sender is transmitted, the ACK packet piggybacks another IP packet (or an IP datagram) to be transmitted through an uplink, i.e. the ACK packet is transmitted together with the IP packet. This removes congestion between the ACK packet and the IP packet, which are transmitted through the uplink, and reduces loss or delay of the ACK packet, which deteriorates the transmission rate.

### PRIORITY

This application claims priority to an application entitled “Method And Terminal And System For Improving Transmission Rate By Using ACK Piggybacking Of TCP In Asynchronous Wireless Network Environment” filed in the Korean Intellectual Property Office on Oct. 7, 2005 and assigned Serial No. 2005-94610, the contents of which are incorporated herein by reference.

### BACKGROUND OF THE INVENTION

1. Field of the Invention

The present invention relates to a method, a terminal and a system for improving data transmission efficiency of a Transmission Control Protocol (TCP), and more particularly to a method, a terminal and a system for improving a transmission rate by using an Acknowledgement (ACK) piggybacking of a TCP in an asynchronous network environment.

2. Description of the Related Art

A TCP is a transmission protocol operating with an Internet Protocol (IP) between terminals, and corresponds to a reliability-based protocol widely used for applications such as a web-based Hyper Text Transfer Protocol (HTTP), e-mail, a Simple Mail Transfer Protocol (SMTP), a File Transfer Protocol (FTP), and a telnet.

Typically, a TCP uses a scheme in which a receiver transmits an Acknowledgement (ACK) packet for confirming to a sender the reception of data in order to improve the reliability for data transmission/reception. Such an ACK packet includes window information for flow control of the data. Herein, a window represents a buffer available at a certain point in time, and a receiver transmits to a sender information on the size of a remaining buffer. Then, the sender confirms the window information, adjusts the size of the window when transmitting subsequent data, and then transmits the subsequent data. If an ACK packet is not received from the receiver within a predetermined period of time in response to such transmission, the sender regards the transmitted data as lost data, and retransmits the corresponding data.

However, in an asynchronous network environment in which an uplink has a bandwidth smaller than that of a downlink, when data is downloaded, a large time delay occurs in transmitting an ACK packet to a sender due to a low bandwidth of a path (i.e. an upstream direction) through which the ACK packet passes. In addition, in view of the self-clocking characteristic of a TCP, the sender determines the data transmission according to whether the ACK packet is received. Therefore, in such an environment, the ACK packet may be lost due to the congestion of the uplink, or a TCP transmission rate may be reduced due to the accumulation of the ACK packet.

If downloading and uploading are performed at the same time, a TCP transmission rate may be considerably reduced. In detail, since competition occurs between an ACK packet for a downloading TCP and upstream data in an uplink, ACK packet transmission of the downloading TCP may become more difficult. In addition, the transmission rate may become increasingly worse due to the delay or loss of the ACK packet.

In such an asynchronous network environment, a scheme for preventing the deterioration of the TCP transmission rate may include a TCP header compression scheme, an ACK filtering scheme, an ACK congestion control scheme, an ACK-First scheduling scheme, a TCP sender adaptation, an ACK reconstruction scheme, etc. The TCP header compression scheme enables transmission of more ACK packets by reducing the size of an upstream ACK packet, thereby preventing the deterioration of TCP performance. The ACK filtering scheme reduces the number of previous ACK packets if the previous ACK packets of the same TCP connection exist in a link layer buffer when the link layer is to transmit upstream ACK packets. The ACK congestion control scheme adjusts the transmission rate of an upstream ACK of a TCP receiver by a method similar to that of the TCP congestion control. The ACK-First scheduling scheme preferentially transmits TCP ACK packets rather than any other IP packets in upstream traffic. In the TCP sender adaptation, a TCP sender transmits a TCP segment in a non-bursty manner based on the expected number of ACK packets. The ACK reconstruction scheme generates ACK packets in an intermediate node at which an asynchronous link ends, thereby preventing a downstream speed from deteriorating.

### SUMMARY OF THE INVENTION

Even though the schemes described above correspond to schemes for solving the deterioration of download performance in a general asynchronous network environment, they take into consideration only a link in one direction, e.g. they take into consideration a downlink and not an uplink. Therefore, in the case of considering only the downlink, ACK packets transmitted from a receiver may not be transferred to a sender, and the sender and the receiver may retransmit ACK packets because they regard the transmitted data as data lost during transmission. Consequently, when these schemes are used, a TCP transmission rate may further deteriorate.

According to the prior art, except for the ACK-First scheduling scheme, the remaining schemes do not take into consideration a case in which bi-directional data transmission simultaneously occurs, and are not suitable for an asynchronous wireless network environment.

Accordingly, the present invention has been made to solve at least the above-mentioned problems, and an object of the present invention is to provide a method, a terminal and a system, which can improve a transmission rate by preventing a TCP transmission rate from being reduced due to the congestion of an uplink when TCP downloading and upstream data transmission are performed at the same time in an asynchronous network environment.

In order to accomplish the aforementioned object, according to one aspect of the present, there is provided a method for improving a data transmission rate by using an ACK piggybacking of a Transmission Control Protocol (TCP) in an asynchronous wireless network environment including a wireless terminal, an intermediate node and a server, the method including determining if there exists an ACK packet to be transmitted to the server in order to enable the server to confirm reception of data downloaded by the wireless terminal; when the corresponding ACK packet exists, determining an uplink traffic situation after placing the ACK packet in a pending state; and when there exists an IP packet to be uploaded, piggybacking the pending ACK packet into a predetermined field of the IP packet, and transmitting the IP packet to the server through the intermediate node.

In order to accomplish the aforementioned object, according to another aspect of the present, there is provided a system for improving a data transmission rate by using an ACK piggybacking of a Transmission Control Protocol (TCP) in an asynchronous wireless network environment, the system including a wireless terminal for, when there exists an ACK packet to be transmitted to a server in order to enable the server to confirm reception of downloaded data, determining if an IP packet to be uploaded exists after placing the corresponding ACK packet in a pending state, piggybacking the ACK packet into a predetermined field of the IP packet, and transmitting the IP packet; and an intermediate node for analyzing the IP packet received from the wireless terminal, determining if the piggybacking ACK packet exists in the received IP packet, and regenerating and forwarding ACK packets by a number of pending ACK packets.

In order to accomplish the aforementioned object, according to further another aspect of the present, there is provided a wireless terminal for improving a data transmission rate by using an ACK piggybacking of a Transmission Control Protocol (TCP) in an asynchronous wireless network environment, the wireless terminal including an uplink traffic detector for determining uplink traffic situation in order to piggyback a pending ACK packet into an IP packet so that a sender confirms reception of downloaded data; an ACK packet piggybacking unit for, when there exists an IP packet to be transmitted through an uplink, piggybacking the ACK packet into a predetermined field of the IP packet; a radio unit for transmitting the IP packet including the ACK packet to the sender; and a controller for, when there exists the ACK packet to be transmitted with respect to the downloaded data, placing the ACK packet in a pending state, determining if there exists the IP packet to be uploaded based on output results from the uplink traffic detector, controlling the ACK packet piggybacking unit so that the ACK packet is piggybacked into the predetermined field of the IP packet when there exists the IP packet to be uploaded, and controlling the radio unit to transmit the IP packet.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of an asynchronous wireless network system according the present invention;

FIG. 2 is a block diagram illustrating the construction of a wireless terminal according to the present invention;

FIGS. 3A and 3B are diagrams illustrating the structure of an IP packet piggybacked by an ACK packet according to the present invention;

FIG. 4 is a flow diagram illustrating a process in which a wireless terminal performs piggybacking according to the present invention;

FIG. 5 is a diagram illustrating a method for computing a transmission time point of a packet to be transmitted through an uplink according to the present invention;

FIG. 6 is a flow diagram illustrating a process in which an intermediate node analyzes a piggybacking ACK packet according to the present invention; and

FIG. 7 is a graph illustrating simulation results of a TCP transmission rate according to the present invention.

### DETAILED DESCRIPTION OF THE PREFERRED EMBODIMENT

Hereinafter, a preferred embodiment according to the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

The present invention improves a TCP transmission rate. For this, when an ACK packet for confirming reception of TCP data downloaded from a sender is transmitted, the ACK packet piggybacks another IP packet (or an IP datagram) to be transmitted through an uplink, i.e. the ACK packet is transmitted together with the IP packet. In this way, it is possible to remove congestion between the ACK packet and the IP packet, which are transmitted through the uplink, and to reduce loss or delay of the ACK packet, which may deteriorate the transmission rate.

Before a description about the present invention is given, a Universal Mobile Telecommunication System (UMTS) network and a Wireless Broadband Internet (Wibro) network, to which the present invention can be applied, will be briefly described.

When a data service is provided by means of an asynchronous wireless network system such as the UMTS network and the Wibro network, downloading actually occurs more frequently than uploading from the viewpoint of a receiver, i.e. a mobile communication terminal. Accordingly, a downlink is set to 384 Kbps and an uplink is set to 64 Kbps. However, even though a large bandwidth is assigned to the downlink and a small bandwidth is assigned to the uplink, competition occurs between uplink data transmission and an ACK packet, which is a response signal for downloading, when downloading and uploading are performed at the same time. Therefore, the ACK packet may be delayed or lost.

In order to solve this problem, a method is required, which can ensure uplink data transmission, i.e. uploading, and simultaneously increase a TCP transmission rate. According to the present invention, when data is transmitted through an uplink, an ACK packet is sent together with the data, so that the flow of uploading data is consistent. Consequently, it is possible to prevent a TCP transmission rate of a downlink from rapidly deteriorating. It goes without saying that the present invention is not limited to an asynchronous wireless network environment, and can also be used for an asynchronous wired network environment.

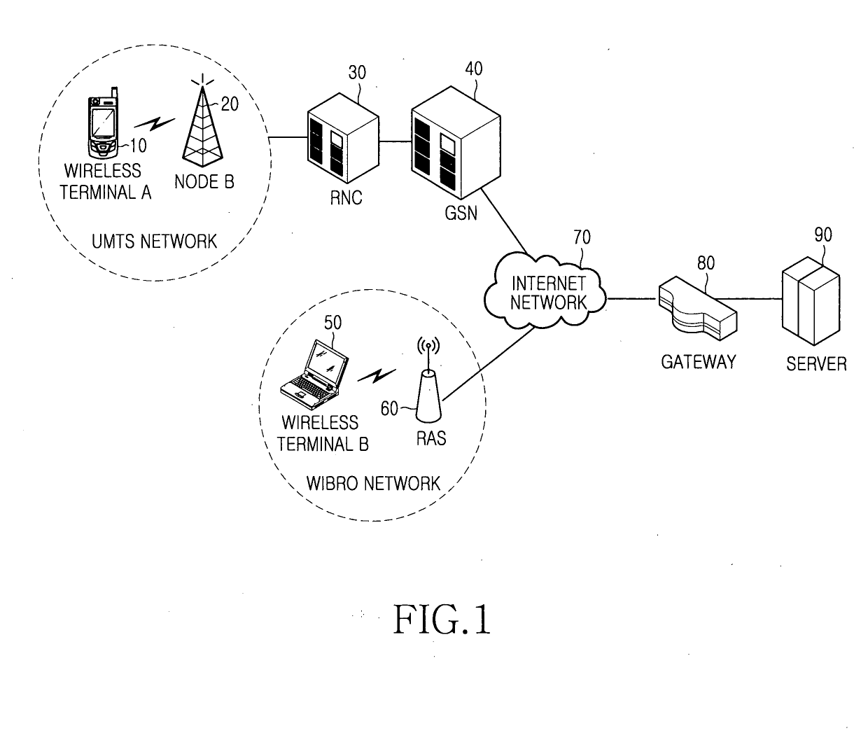

FIG. 1 is a block diagram illustrating the construction of an asynchronous wireless network system according to the present invention. FIG. 1 shows an asynchronous wireless network environment such as a UMTS network and a Wibro network.

First, a wireless terminal 10 receives downlink data or transmits uplink data through a node 20 on a UMTS network, and a Ratio Network Controller (RNC) 30 functions as an access point for connecting the node 20 to a sender, i.e. a server 90. Further, a General Packet Ratio Service (GPRS) Support Node [GSN] 40 is connected to the sender, i.e. the server 90, through a gateway 80 in cooperation with the Internet network 70 or the RNC 30. The GSN 40 is the general term for both a Serving GSN (SGSN) operating in connection with the node 20, and a Gateway GSN (GGSN) operating in connection with the Internet network 70.

Further, a wireless terminal 50 may access the server 90 through a Remote Access Server (RAS) 60, which may access a network such as the Internet network 70, via the gateway 80. The gateway 80 is used for connecting the server 90 to another communication network, and corresponds to a network point which functions as an entrance point permitting access to another communication network. That is, when two different communication networks, e.g. a UMTS network and a Wibro network, are used, a gateway is required.

Specifically, in the UMTS network and the Wibro network (asynchronous wireless networks) to which the present invention is applied, an intermediate node is provided in order to improve the performance of a wireless network. In the UMTS network, the GSN 40, i.e. the GGSN, may function as the intermediate node. In the Wibro network, the RAS 60 may function as the intermediate node. The intermediate node represents a network element through which data being downloaded or uploaded always pass. In the wireless network as described above, since the intermediate node such as the GGSN and the RAS 60 corresponds to a node through which all uplink packets pass, the present invention can be applied to such an intermediate node in order to improve TCP performance.

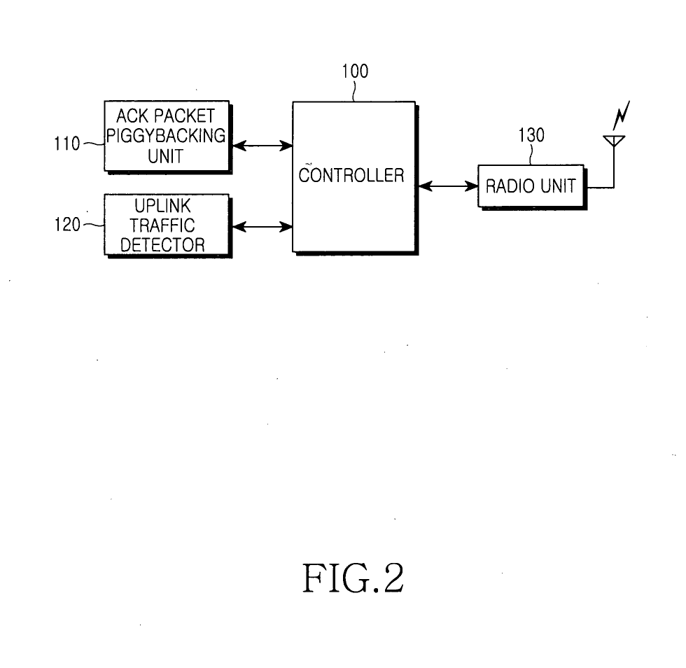

Hereinafter, the operations of the wireless terminal for improving the performance of TCP download, i.e. a transmission rate, in an asynchronous wireless network while interworking with the intermediate node will be described in detail with reference to FIG. 2. FIG. 2 is a block diagram illustrating the construction of the wireless terminal according to one embodiment of the present invention.

As illustrated in FIG. 2, the wireless terminal according to the present invention includes a controller 100, an ACK packet piggybacking unit 110, an uplink traffic detector 120, and a radio unit 130.

The controller 100 controls the general operation of the wireless terminal. Specifically, the controller 100 controls each element so that an ACK packet can be transmitted together with an IP packet in order to enable a sender to confirm reception of downloaded data, instead of generating the ACK packet as a single IP packet and transmitting the single IP packet. In detail, the controller 100 determines if there exist data to be uploaded through the uplink traffic detector 120. When there exist data (upload data) to be uploaded, the controller 100 loads the ACK packet into the upload data through the ACK packet piggybacking unit 110, and transmits the upload data including the ACK packet through the radio unit 130.

The ACK packet piggybacking unit 110 corresponds to a module that causes the ACK packet of download TCP connection to be piggybacked into a predetermined field of an IP packet transmitted through an uplink for another TCP connection or another application, instead of generating the ACK packet as a single packet.

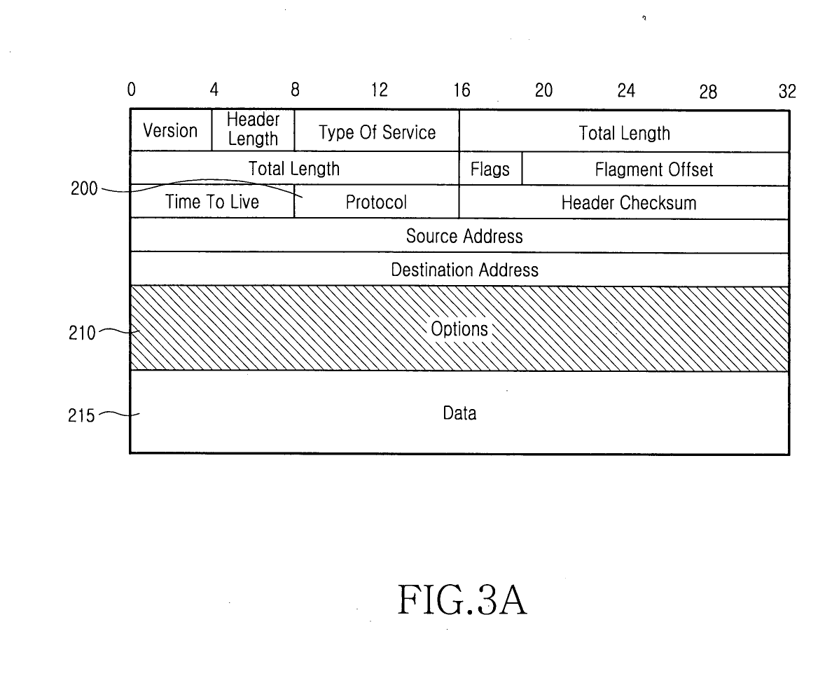

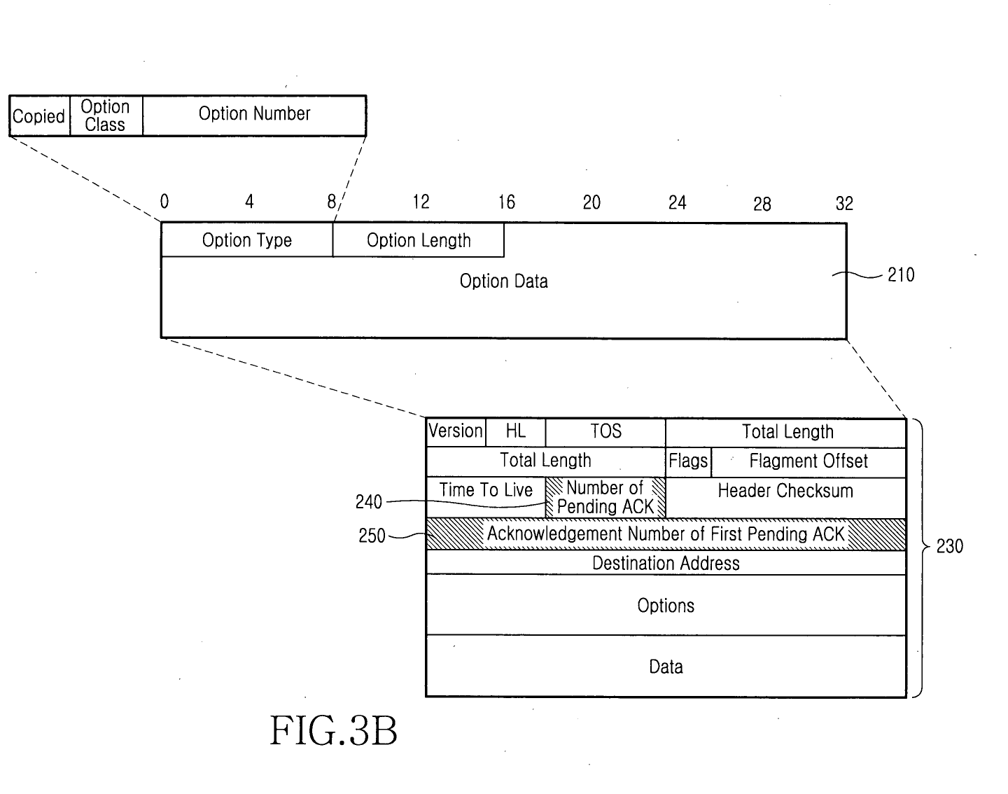

Hereinafter, the structure of an IP datagram (i.e. an IP packet) transmitted through an uplink will be briefly described with reference to FIGS. 3A and 3B. The IP packet includes fields as illustrated in FIG. 3A. For example, a ‘TCP’, which is a transmission protocol operating with an IP between terminals, is set in the protocol field 200 of the IP packet. That is, since the fields are used in a similar manner as the fields of a typical IP packet, a detailed description about each field will be omitted. The present invention exemplifies a case of piggybacking an ACK packet into the option field 210 of the IP packet. Herein, the ACK packet may also be piggybacked into the data field 215.

FIG. 3B illustrates the detailed structure of the option field 210 of the IP packet. As illustrated in FIG. 3B, the option field 210 may be largely divided into an option type field, an option length field, an option data field including data, etc. Among these fields, the ACK packet, which is a reception response for a download TCP, is actually piggybacked into the option data field. The piggybacking ACK packet has a structure as indicated by a reference number 230. As indicated by the reference number 230, it can be understood that the ACK packet loaded on the IP packet has the same structure as that of a typical IP packet. However, in the structure of the ACK packet, information regarding the accomplishment of the piggybacking process according to the present invention is set in fields corresponding to both the protocol field and the source address field of the existing IP packet.

For example, a ‘TCP’ representing the type of a protocol is set in the existing protocol field. However, in the present invention, since it is natural that packet transmission is performed based on the TCP, the number of pending ACK packets is set in the field as indicated by a reference number 240, instead of the ‘TCP’. Further, since the field as indicated by a reference number 250, i.e. the field in which the source address of the ACK packet is set, corresponds to a field in which information equal to the source address of an uplink IP packet is set, the acknowledgement number of first pending ACK packets is set in this field according to the present invention.

In a case in which the ACK packet is piggybacked into the IP packet and is transmitted to the sender via the intermediate node as described above, the intermediate node reconstructs the pending ACK packets based on both the number of pending ACK packets set in the field 240 and the acknowledgement number of the first pending ACK packets, having been set in the field 250, in the ACK packet included in the option field 210 of the IP packet. Accordingly, the intermediate node restores the fields as indicated by the reference numbers 240 and 250 as the protocol field and the source address field, respectively, sets the corresponding information (i.e. ‘TCP’ and source address information) in the fields, respectively, and generates the ACK packet.

The option type field 220 may include information which informs the intermediate node whether a piggybacking ACK packet exists in an IP packet received from the wireless terminal. If an uplink IP packet is received before all of the IP packets, which are transferred from the wireless terminal (receiver) through an uplink, arrive at the server (sender), the intermediate node determines if a piggybacking ACK packet exists in the uplink IP packet through the option type field 220. As a result of the determination, when the piggybacking ACK packet exists, the intermediate node confirms the number of pending ACK packets, and regenerates and forwards ACK packets by the corresponding number of pending ACK packets.

The uplink traffic detector 120 determines if the uplink traffic frequently occurs, i.e. if data to be upload exist, in order to cause an ACK packet to be piggybacked into an IP packet. This process is necessary in order to determine if the performance improvement using ACK piggybacking is possible based on the traffic situation of an uplink channel at the point in time, at which ACK packet transmission is necessary, for confirming reception of data for download. When the uplink traffic frequently occurs at the point in time at which the ACK packet transmission is necessary, an ACK packet is placed in a pending state and then is “piggybacked into a subsequent IP packet to be uploaded. The present invention can prevent the performance of the TCP download from deteriorating due to the uplink traffic. However, when the uplink traffic does not frequently occur, an ACK packet is generated as a single packet and then is transmitted as in the conventional case.

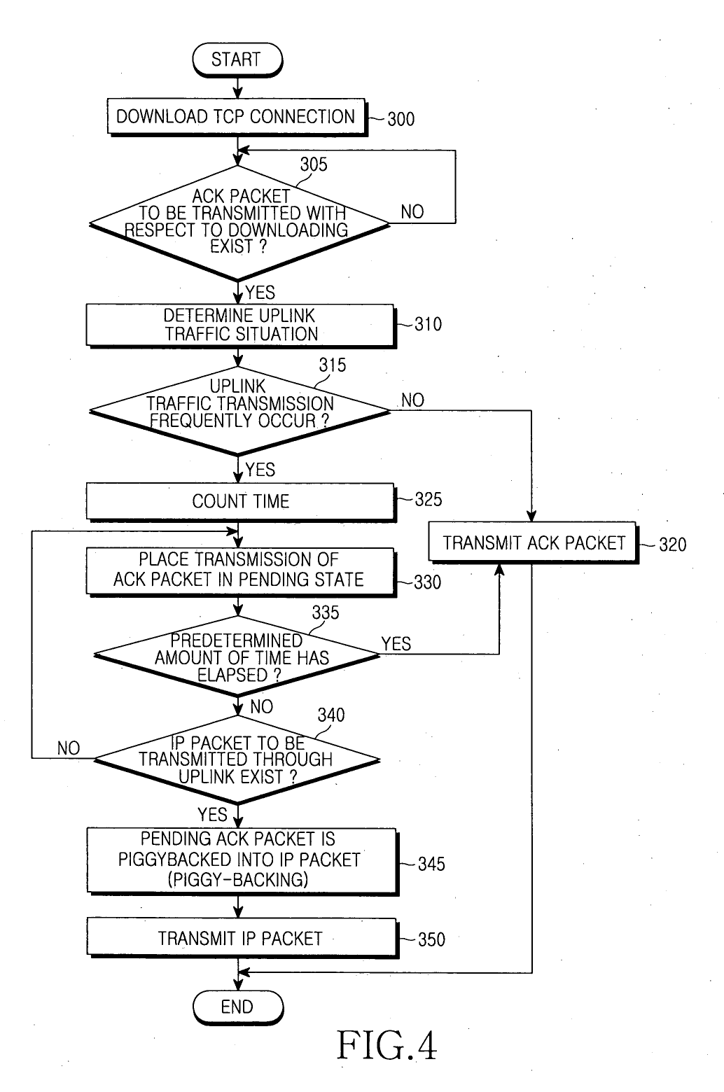

FIG. 4 is a flow diagram illustrating the process in which the wireless terminal performs the piggybacking according to the present invention.

Referring to FIG. 4, in step 300, the wireless terminal performs download TCP connection. In step 305, the wireless terminal determine if there exists an ACK packet to be transmitted with respect to downloading, in order to enable the sender to confirm reception of downloaded data. When the data has been normally received, the wireless terminal generates an ACK packet for reception confirmation of the data. Accordingly, when there exists the ACK packet to be transmitted, the wireless terminal determines the uplink traffic situation in step 310. In step 315, the wireless terminal determines if uplink traffic transmission frequently occurs. Herein, the determination regarding the uplink traffic situation is periodically performed by the uplink traffic detector 120. That is, the uplink traffic detector 120 continues to perform the determination regarding whether the uplink traffic frequently occurs.

The reason for observing the uplink traffic situation is that, if data to be uploaded is frequently generated, sending the data after waiting for an ACK packet and then loading the ACK packet on the data can prevent the loss of the ACK packet due to the congestion of an uplink and thus improve a TCP transmission rate. However, when the data to be uploaded is not frequently generated, waiting for the data to be uploaded and then loading an ACK packet on the data may cause a significant delay until the data is transferred to the sender. In such a case, it is more efficient to directly transmit the ACK packet itself to the sender. In this way, it is possible to prevent the TCP transmission rate from being reduced due to accumulation of the ACK packet.

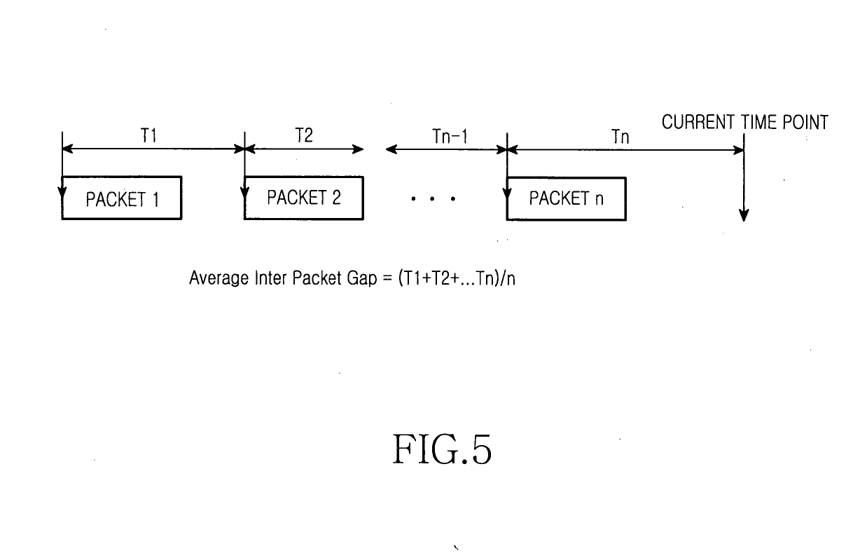

According to the present invention, the uplink traffic situation is determined based on various methods. FIG. 5 is a diagram illustrating a method for computing a transmission time point of a packet to be transmitted through an uplink according to the present invention.

Referring to FIG. 5, it is assumed that a packet 1 has a transmission period of T1. That is, the T1 represents a period of time from the current transmission point in time of the packet 1 up to just before the transmission of a subsequent packet starts. Then, it is possible to compute an average transmission period of N uplink packets, which have been recently transmitted, by means of the transmission periods T1 to Tn of each packet. The average is obtained by dividing a sum of packet transmission periods for a predetermined number of packets by the predetermined number of the packets, wherein each of the packet transmission periods is obtained by measuring the period of time from the transmission time of one packet up to just before the transmission of a subsequent packet starts. Further, an average inter-packet gap is computed through this process, so that a subsequent transmission time can be predicted. Herein, the average inter-packet gap is periodically updated or is updated whenever an IP packet is transmitted through an uplink. In this way, the transmission time of a subsequent packet to be transmitted can be predicted through the average inter-packet gap, so that it is possible to determine that the subsequent transmission time will be earlier when the average inter-packet gap is less than a threshold value. That is, it is possible to determine that an IP packet to be uploaded exists because uplink traffic frequently occurs. However, when the average inter-packet gap is greater than the threshold value, it is determined that the uplink traffic does not frequently occur.

Among the methods for determining the uplink traffic situation, it is also possible to determine whether uplink traffic frequently occurs based on a difference between a bandwidth assigned to an uplink and a bandwidth currently in use.

In step 315, when it is determined that the uplink traffic transmission frequently occurs by means of the method for determining the uplink traffic situation as described above, step 325 is performed. That is, the wireless terminal counts the time. In step 330, the wireless terminal places the transmission of an ACK packet in a pending state, i.e. in a waiting state. However, in step 315, when it is determined that the uplink traffic transmission does not frequently occur, step 320 is performed. That is, the wireless terminal generates and transmits a typical ACK packet. In step 335, the wireless terminal determines if a predetermined amount of time has elapsed during the counting of the time, because uplink traffic does not occur within a predetermined time. If the time has fully elapsed, the wireless terminal transmits all pending ACK packets in step 320.

However, if the time has not fully elapsed, i.e. if the timer counts out, step 340 is performed. That is, the wireless terminal determines if uplink traffic occurs within a predetermined time and an IP packet to be transmitted through an uplink exists. The wireless terminal determines if there exists a packet to be transmitted through an uplink, i.e. an IP packet of another upload TCP or another application. If the corresponding packet exists, step 345 is performed. That is, the wireless terminal causes a pending ACK packet to be piggybacked into the IP packet to be transmitted through the uplink. The wireless terminal sets the number of pending ACK packets up to now in the field 240, and sets the acknowledgement number of first pending ACK packets in the field 250, which belong to the field structure of the ACK packet to perform piggybacking through the ACK packet piggybacking unit 110. Then, the wireless terminal causes the ACK packet having the structure as described above to be piggybacked into the option field 210 of the IP packet. In step 350, the wireless terminal transmits the IP packet piggybacked by the ACK packet to the sender.

Further, the IP packet transmitted from the wireless terminal (receiver) passes through the intermediate node in order to be transmitted to the sender. The intermediate node according to the present invention determines if the piggybacking ACK packet exists in the IP packet received from the wireless terminal.

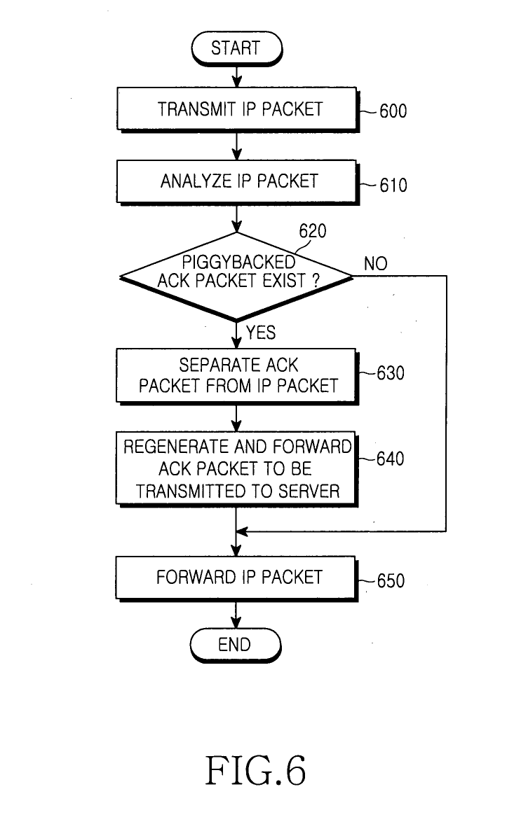

FIG. 6 is a flow diagram illustrating the process in which the intermediate node analyzes the piggybacking ACK packet according to the present invention.

First, in step 600, if the IP packet to be transmitted through the uplink is received from the wireless terminal, step 610 is performed. That is, the intermediate node analyzes the IP packet. Herein, the intermediate node confirms information set in the option type field of the option field 210 in the IP packet structure and can determine if an ACK packet has been piggybacked into the IP packet. In step 620, the intermediate node determines if the piggybacking ACK packet exists based on results obtained by confirming the option type of the option field 210. If the piggybacking ACK packet exists, step 630 is performed. That is, the intermediate node separates the ACK packet from the IP packet to be transmitted through the uplink. In step 640, the intermediate node regenerates and forwards an ACK packet to be transmitted to the server.

A process for regenerating the ACK packet is accomplished through the following operations. First, the intermediate node restructures ACK packets by the number of pending ACK packets based on both the number of pending ACK packets set in the field 240, and the acknowledgement number of first pending ACK packets, which has been set in the field 250, in the ACK packet included in the option field of the IP packet. Then, the intermediate node restores the fields as indicated by the reference numbers 240 and 250 as the protocol field and the source address field, respectively, sets corresponding information (i.e. ‘TCP’ and source address information) in the fields, respectively, and regenerates the ACK packet. While the intermediate node regenerates and forwards the ACK packet, the intermediate node forwards the IP packet from which the piggybacking ACK packet has been separated, in step 650.

According to the present invention as described above, in order to improve the TCP transmission rate, an ACK packet, which is a reception response for TCP download, is piggybacked into another IP packet to be transmitted through an uplink, and then is transmitted together with the other IP packet, so that competition between the ACK packet and data to be transmitted through an uplink can be removed. It is possible to reduce the loss or delay of the ACK packet, which may deteriorate downloading performance.

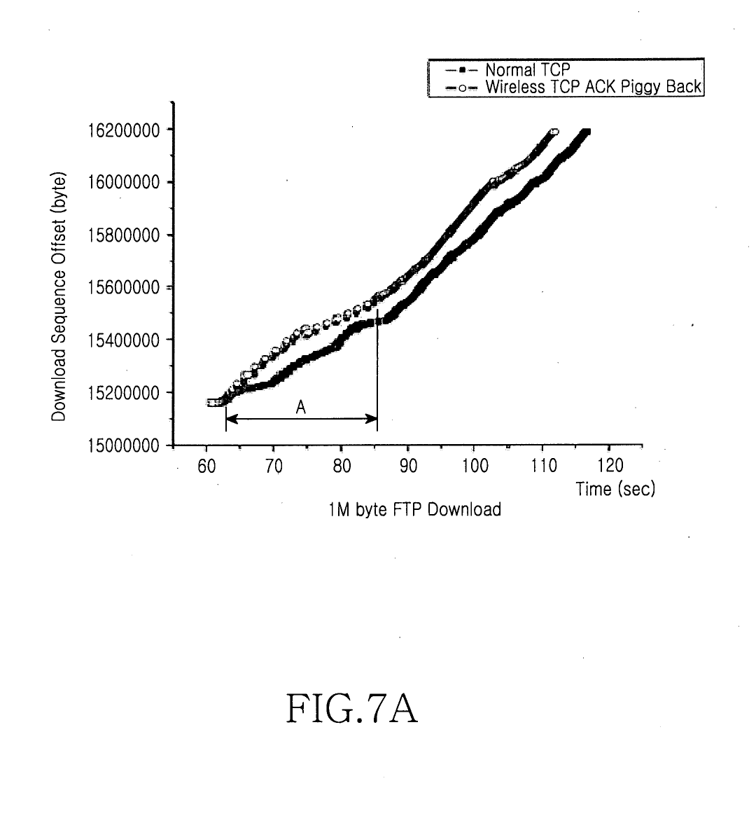

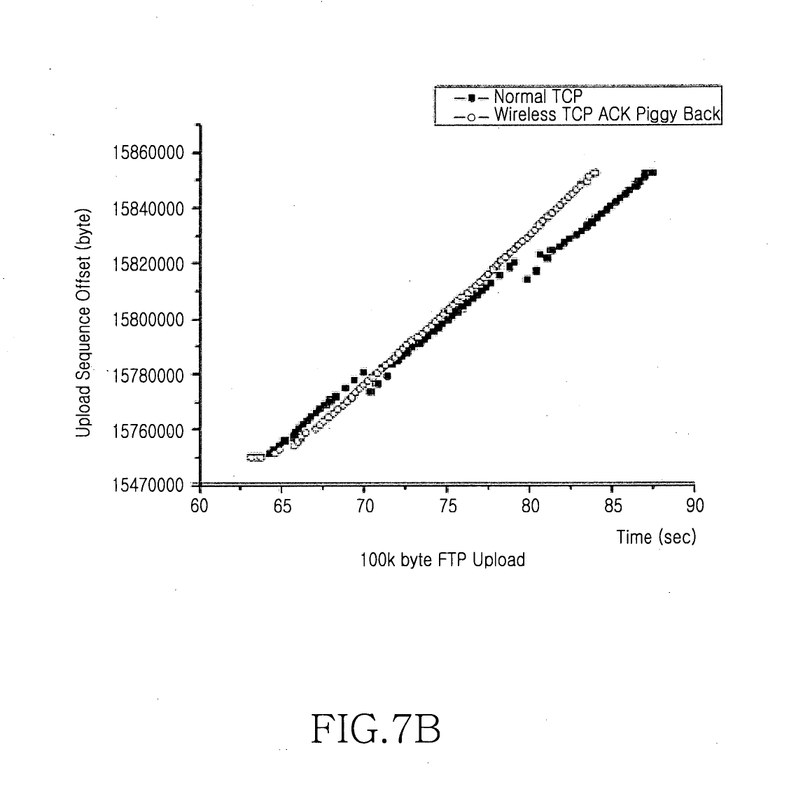

FIGS. 7A and 7B are graphs illustrating the simulation results of the TCP transmission rate according to the present invention.

FIGS. 7A and 7B illustrate the improvement of TCP performance when a downlink speed was set to 384 Kbps and an uplink speed was set to 64 Kbps in a simulator UMTS network. FIG. 7A illustrates the simulation results when FTP downloading of 1 Mbyte started at a time of 60 seconds, and FIG. 7B illustrates the simulation results when FTP uploading of 100 Mbytes was performed at a time of 63 seconds. In the graphs as illustrated in FIGS. 7A and 7B, each horizontal axis commonly represents a time axis, and vertical axes represents a download sequence offset axis and an upload sequence offset axis.

Referring to FIG. 7A, the line plotted by black color represents a normal TCP, and the line plotted by white color represents the simulation results when the present invention was applied. Specifically, an interval A indicates a case in which downloading and uploading simultaneously occur. When an ACK packet is piggybacked by using the present invention, it can be understood that the line plotted by the white color has a relatively large slope, as compared with the line plotted by black color representing the normal TCP. Since the slope represents the TCP transmission rate in the simulation results, it can be understood that the TCP transmission rate becomes better as the slope becomes greater. As in the case of the downloading in FIG. 7A, even in the uploading in FIG. 7B, the line plotted by white color, which represents a case of piggybacking an ACK packet, has a slope greater than that of the line plotted by black color representing the normal TCP. Accordingly, it can be understood that that the TCP transmission rate was improved. FIGS. 7A and 7B show the simulation results when uploading started during downloading. Accordingly, when downloading occurred during uploading, it is expected that it is possible to obtain greater gain due to the effect of the slot-start of the TCP according to the present invention.

According to the present invention as described above, when uplink and -downlink traffic simultaneously occur in an asynchronous wireless network environment, an ACK packet is piggybacked into an IP packet based on traffic situation, so that it is possible to remove congestion of an uplink and to reduce the loss or delay of the ACK packet, which may deteriorate a transmission rate. Consequently, a TCP transmission rate can be improved. In addition, if an intermediate node is also provided to a wired network as well as the asynchronous wireless network, the present invention can be realized.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for improving a data transmission rate by using an acknowledgement (ACK) piggybacking of a Transmission Control Protocol (TCP) in an asynchronous wireless network environment including a first node, an intermediate node and a second node, the method comprising the steps of:
determining if there exists an ACK packet to be transmitted to the second node from the first node;
when the corresponding ACK packet exists, determining an uplink traffic situation after placing the ACK packet in a pending state; and
when there exists an IP packet to be uploaded, piggybacking the pending ACK packet into a field of the IP packet, and transmitting the IP packet to the second node through the intermediate node.

2. The method as claimed in claim 1, further comprising the steps of:
starting a timer while placing the ACK packet in the pending state and determining if there exists an IP packet to be uploaded within a predetermined time; and
if a predetermined amount of time has elapsed due to absence of the IP packet to be uploaded, transmitting the pending ACK packet.

3. The method as claimed in claim 1, wherein the step of determining the uplink traffic situation comprises the sub-steps of:
computing an average inter-packet gap for a number of recently transmitted packets; and
comparing the average inter-packet gap with a threshold value, and determining that there exists an IP packet to be uploaded when the average inter-packet gap has a value less than threshold value.

4. The method as claimed in claim 3, wherein the average inter-packet gap is obtained by dividing a sum of packet transmission periods for a number of packets by the number of the packets, each of the packet transmission periods being obtained by measuring a time from a transmission time of one packet up to just before transmission of a subsequent packet starts.

5. The method as claimed in claim 1, wherein, in the step of transmitting the IP packet, the ACK packet is included in an option field of the IP packet and is transmitted, the ACK packet having a first field in which a number of currently pending ACK packets is set and a second field in which an acknowledgement number of first pending ACK packets is set, the first field corresponding to a protocol field, the second field corresponding to a source address field, and the protocol field and the source address field being included in a field structure of the ACK packet.

6. The method as claimed in claim 5, further comprising the steps of:
if the intermediate node receives the IP packet, determining if the piggybacking ACK packet exists in the received IP packet;
when the piggybacking ACK packet exists in the received IP packet, separating the piggybacking ACK packet from the IP packet;
regenerating ACK packets according to the number of currently pending ACK packets and the acknowledgement number of first pending ACK packets, which are included in the ACK packet; and
forwarding both the IP packet, from which the piggybacking ACK packet has been separated, and the regenerated ACK packet.

7. A system for improving a data transmission rate by using an acknowledgment (ACK) piggybacking of a Transmission Control Protocol (TCP) in an asynchronous wireless network environment, the system comprising:
a first node for, when there exists an ACK packet to be transmitted to a second node to confirm reception of downloaded data, determining if an IP packet to be uploaded exists after placing a corresponding ACK packet in a pending state, causing the ACK packet to be piggybacked into a field of the IP packet, and transmitting the IP packet; and
an intermediate node for analyzing the IP packet received from the first node, determining if the piggybacking ACK packet exists in the received IP packet, and regenerating and forwarding ACK packets by a number of pending ACK packets.

8. The system as claimed in claim 7, wherein the wireless terminal starts a timer while placing the ACK packet in the pending state, determines if there exists the IP packet to be uploaded within a predetermined time, and transmits the pending ACK packet if a predetermined amount of time has elapsed due to absence of the IP packet to be uploaded.

9. The system as claimed in claim 7, wherein the wireless terminal starts a timer while placing the ACK packet in the pending state, determines if there exists the IP packet to be uploaded within a predetermined time, and transmits the pending ACK packet if there exists no IP packet to be uploaded.

10. The system as claimed in claim 7, wherein the first node computes an average inter-packet gap for a number of recently transmitted packets, compares the average inter-packet gap with a threshold value, and determines that there exists an IP packet to be uploaded when the average inter-packet gap has a value less than threshold value.

11. The system as claimed in claim 10, wherein the average inter-packet gap is obtained by dividing a sum of packet transmission periods for a number of packets by the number of the packets, each of the packet transmission periods being obtained by measuring a time from a transmission time of one packet up to just before transmission of a subsequent packet starts.

12. The system as claimed in claim 10, wherein the ACK packet piggybacked into the field of the IP packet has a field structure in which a number of currently pending ACK packets is set in a field corresponding to a protocol field, and an acknowledgement number of first pending ACK packets is set in a field corresponding to a source address field.

13. The system as claimed in claim 10, wherein the piggybacking ACK packet is included in either an option field or a data field of the IP packet.

14. The system as claimed in claim 7, wherein the intermediate node determines if the piggybacking ACK packet exists in an IP packet if the IP packet is received, separates the piggybacking ACK packet from the IP packet when the piggybacking ACK packet exists in the IP packet, regenerates ACK packets according to a number of currently pending ACK packets and an acknowledgement number of first pending ACK packets, which are included in the separated ACK packet, and forwards both the IP packet, from which the piggybacking ACK packet has been separated, and the regenerated ACK packet.

15. The system as claimed in claim 7, wherein the wireless terminal determines if the IP packet to be uploaded exists based on a difference value between a bandwidth assigned to an uplink and a bandwidth currently in use.

16. A wireless terminal for improving a data transmission rate by using an acknowledgment (ACK) piggybacking of a Transmission Control Protocol (TCP) in an asynchronous wireless network environment, the wireless terminal comprising:
an uplink traffic detector for determining an uplink traffic situation in order to cause a pending ACK packet to be piggybacked into an IP packet so that a sender can confirm reception of downloaded data;
an ACK packet piggybacking unit for, when there exists an IP packet to be transmitted through an uplink, causing the ACK packet to be piggybacked into a field of the IP packet;
a radio unit for transmitting to the sender the IP packet including the ACK packet; and
a controller for, when there exists the ACK packet to be transmitted with respect to the downloaded data, placing the ACK packet in a pending state, determining if there exists the IP packet to be uploaded based on output results from the uplink traffic detector, controlling the ACK packet piggybacking unit so that the ACK packet is piggybacked into the field of the IP packet when there exists the IP packet to be uploaded, and controlling the radio unit to transmit the IP packet.

17. The wireless terminal as claimed in claim 16, wherein the controller starts a timer while placing the ACK packet in the pending state, determines if there exists the IP packet to be uploaded within a predetermined time, and transmits the pending ACK packet if there exists no IP packet to be uploaded.

18. The wireless terminal as claimed in claim 16, wherein the controller starts a timer while placing the ACK packet in the pending state, and transmits the pending ACK packet if a predetermined amount of time has elapsed due to absence of the IP packet to be uploaded within a predetermined time.
